(19) United States
(12) Patent Application Publication
(10) Pub. No.: US 2014/0052473 A1
(43) Pub. Date: Feb. 20, 2014

(54) Method and System for Coordinating Healthcare and Human Services

(71) Applicant: Monica Stynchula, Tampa, FL (US)

(72) Inventor: Monica Stynchula, Tampa, FL (US)

(21) Appl. No.: 13/960,076

(22) Filed: Aug. 6, 2013

Related U.S. Application Data
(60) Provisional application No. 61/681,177, filed on Aug. 9, 2012.

(51) Int. Cl. G06F 19/00

(52) U.S. Cl. CPC G06F 19/322
USPC 705/3

(57) ABSTRACT

Disclosed is a system and method for coordinating health care decisions between a participant in the health care system, the health care providers for the participant, the various subscribers, who may be the loved ones of the participant. By way of the system and method, the participant can take a more active role in making decisions regarding long term care. The participant can be effectively monitored by the health care providers and subscribers to that the participant can live safely in the least restrictive environment. The system and method also improves communication between the three groups of people and ensures that treatments and end of life decisions are upheld.

### RELATED APPLICATION DATA

This application claims priority to co-pending application Ser. No. 61/681,177 filed on Aug. 9, 2012 and entitled “Method and System for Coordinating Healthcare and Human Services.” The contents of this application are fully incorporated herein for all purposes.

### BACKGROUND OF THE INVENTION

1. Field of the Invention

The present disclosure relates to a system and method for health care coordination. More specifically, the disclosure relates to a system of coordination between a health care participant, subscribers, and health care professionals. The system seeks diversion from long term care institutional placement for convalescence, palliative and end of life care for patients and their families.

2. Description of the Background Art

Presently, there exist numerous methods for the coordination of healthcare safety and palliative and end-of-life care to the exclusion of human service and home based health services. This invention relates to a method for interoperable and secure coordination and monitoring of home based healthcare.

The present invention utilizes a consumer-driven website to communicate with family, loved ones and healthcare providers and professionals.

An object of this invention is to enable consumers to monitor the healthcare of a loved one via a website to ensure healthcare decisions are made in a convenient and easy manner from anywhere.

Another object of this invention is to provide a method to enable users of the website to subscribe to a website specifically directed to the healthcare of a loved one, significant other or family manner.

Another object of the present invention is to offer quality, usable communication formats to keep people engaged in each other's lives.

Another object of this invention is to permit users of the present invention to make informed decisions based upon information communicated by healthcare providers and professionals without having to meet face-to-face with other family members or healthcare professionals.

Another object of this invention is to allow patients and their loved ones to play an active role versus a passive role in their healthcare.

Therefore, it is an object of this invention to provide an improvement which overcomes the aforementioned inadequacies of the prior art devices and provides a method for monitoring and communicating healthcare decisions via a website which is a significant contribution to the advancement of the communication between patients, healthcare professionals and families.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purposes of summarizing this invention, the invention comprises a method for patients, their families or loved ones to communicate with healthcare providers and professionals. Specifically, the present invention provides for a website driven by consumers designed as an innovation for health and human services. Communication between patients, their families and healthcare professionals is streamlined and plans concerning the patient are made using the website in a proactive manner. Use of the website empowers consumers to invite and create a circle of subscribers including family, friends, caregivers and professionals.

More specifically, the method of the present invention enables users of the website to (1) monitor the consumer living in the safest least restrictive environment with periodic assessment of abilities; (2) improve communication between consumers, significant others/family members and/or loved ones and healthcare providers; and (3) uphold treatments and end of life decisions made by consumers.

Various embodiments of the disclosure may have none, some, or all of these advantages. Other technical advantages of the present disclosure will be readily apparent to one skilled in the art.

### BRIEF DESCRIPTION OF THE DRAWINGS

For a fuller understanding of the nature and objects of the invention, reference should be had to the following detailed description taken in connection with the accompanying drawings in which:

FIG. 1 is a diagram illustrating the relationship between the participant, health care providers, and subscribers.

FIG. 2 is a diagram illustrating the various self-assessments the participant makes as part of the system.

FIG. 3 is a diagram illustrating the various information the participant may collect as part of the system.

FIG. 4 is a table illustrating the participant health care form.

FIG. 5 is a table illustrating the daily living assessment.

FIG. 6 is a table illustrating the home safety and mobility assessment.

FIG. 7 is a table illustrating the nutrition and eating habit assessment.

FIG. 8 is a table illustrating time of death and after death decisions the participant may make.

FIG. 9 is a table illustrating the participant's health care team member information.

FIG. 10 is a table illustrating the participant's financial and legal team contact information.

FIG. 11 is a table illustrating the participant's financial information

FIG. 12 is a table illustrating the participant's monthly income and expense information.

FIG. 13 is a table listing the types of documents the participant may store in the vault feature of the present system.

FIG. 14 is a schematic high level overview of the present system.

FIG. 15 is an additional high level schematic of the present system.

Similar reference characters refer to similar parts throughout the several views of the drawings.

### DETAILED DESCRIPTION OF THE PREFERRED EMBODIMENT

The present disclosure relates to a system and method for coordinating health care decisions between a participant in the health care system, the health care providers for the participant, the various subscribers, who may be the loved ones of the participant. By way of the system and method, the participant can take a more active role in making decisions regarding long term care. The participant can be effectively monitored by the health care providers and subscribers so that the participant can live safely in the least restrictive environment. The system and method also improves communication between the three groups of people and ensures that treatments and end of life decisions are upheld. The various components of the present system, and the manner in which they interrelate, are described in greater detail hereinafter.

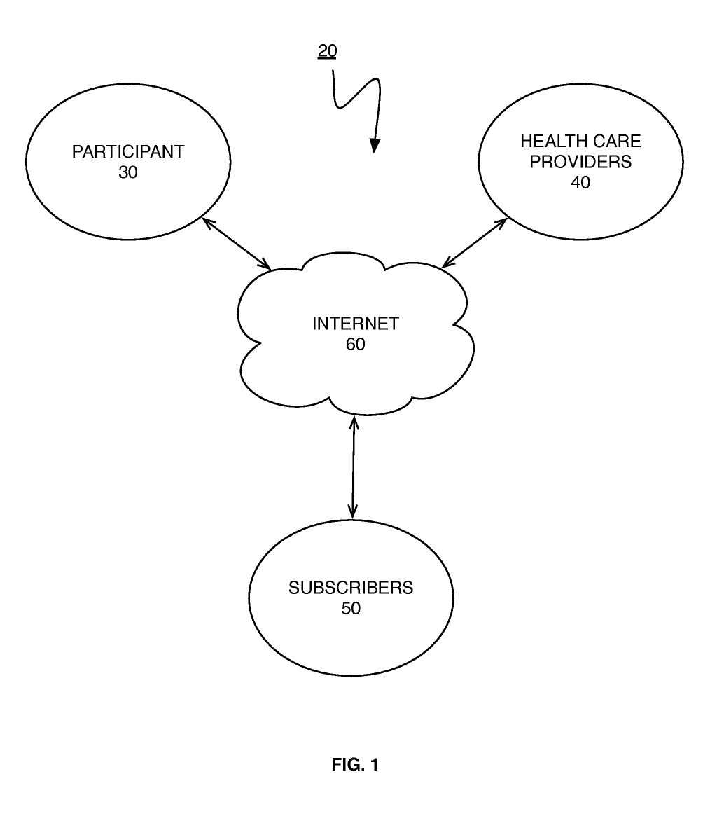

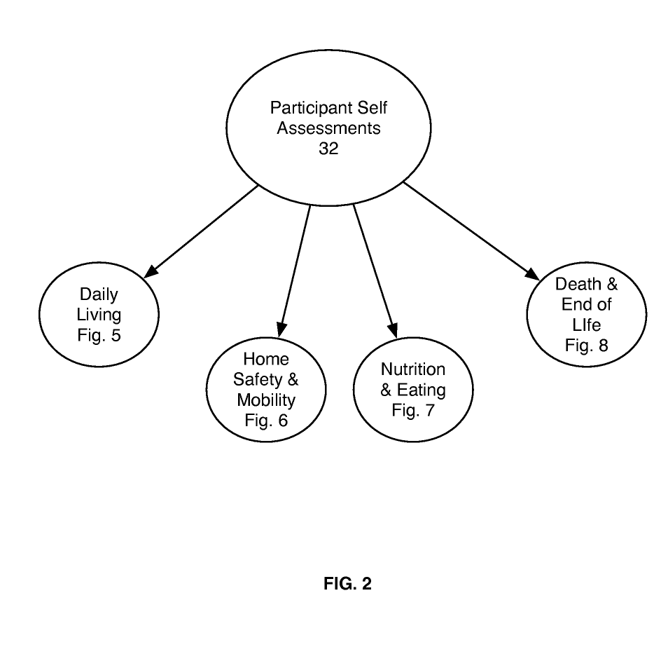

One potential embodiment of the present invention is described in connection with FIGS. 1 and 2. As illustrated, the invention allows a participant 30 to communicate with health care providers 40 and subscribers 50. The participants 30 can be anyone in need of heath care. For example, a participant 30 could be an elderly person living at home. It could also be someone with a mental or physical handicap. The health care providers 40 can be doctors, nurses, physical therapists, or social workers. Subscribers 50 can be any number of friends or loved ones who are interested in the well-being of a particular participant 30.

The participant 30, health care providers 40, and subscribers 50 are connected to one another over a network 60. This network 60 allows the three groups to communicate with one another via telephone, email, or video. It also provides a portal by which the three groups can access a secure database. In the depicted example, the network 60 is the global computer network known as the Internet. Nonetheless, as used herein, the term network refers to wireless or wireline communication that can be carried out via any number of known protocols, including, but not limited to, Internet Protocol (IP), Wireless Access Protocol (WAP), Frame Relay, or Asynchronous Transfer Mode (ATM). Any other suitable protocols using voice, video, data, or combinations thereof, can also be employed. The network may include one or more local area networks (LANs), radio access networks (RANs), metropolitan area networks (MANS), wide area networks (WANs), and/or any other communication system or systems at one or more locations.

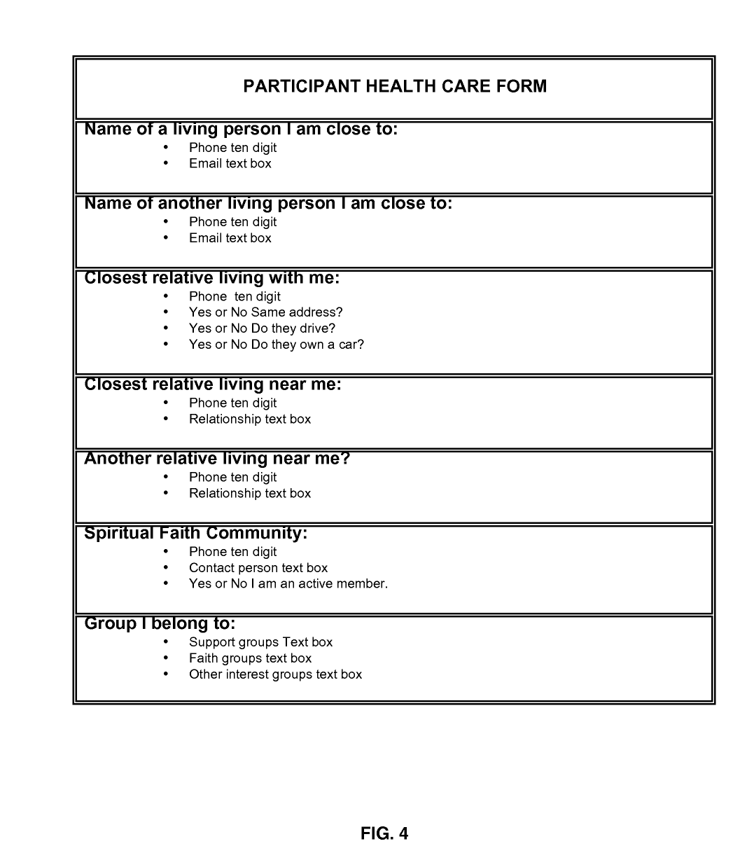

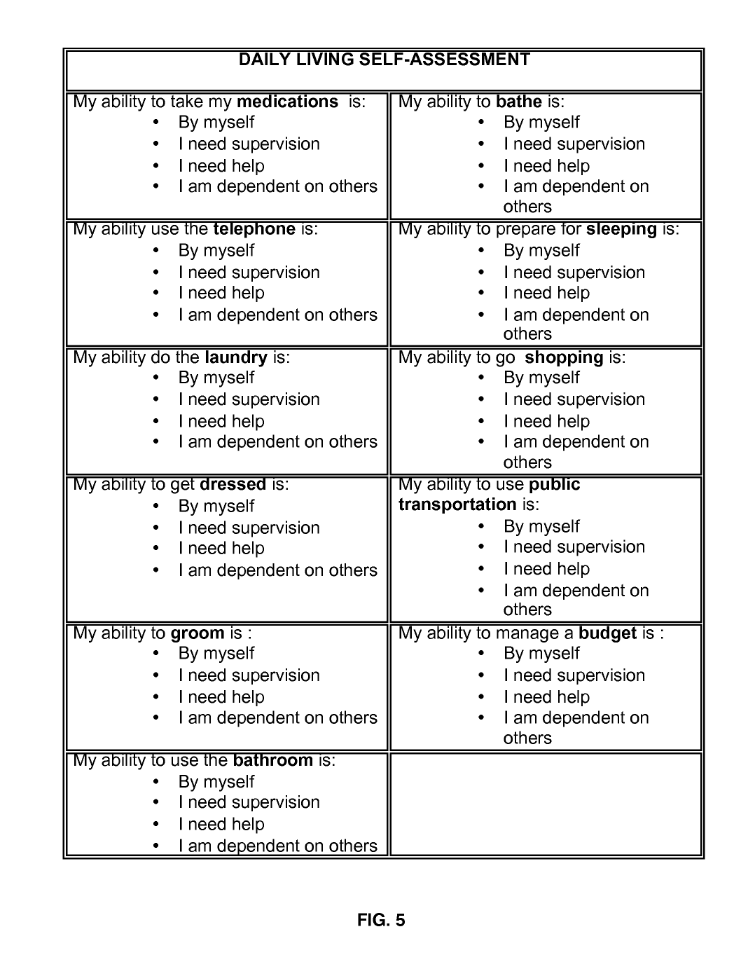

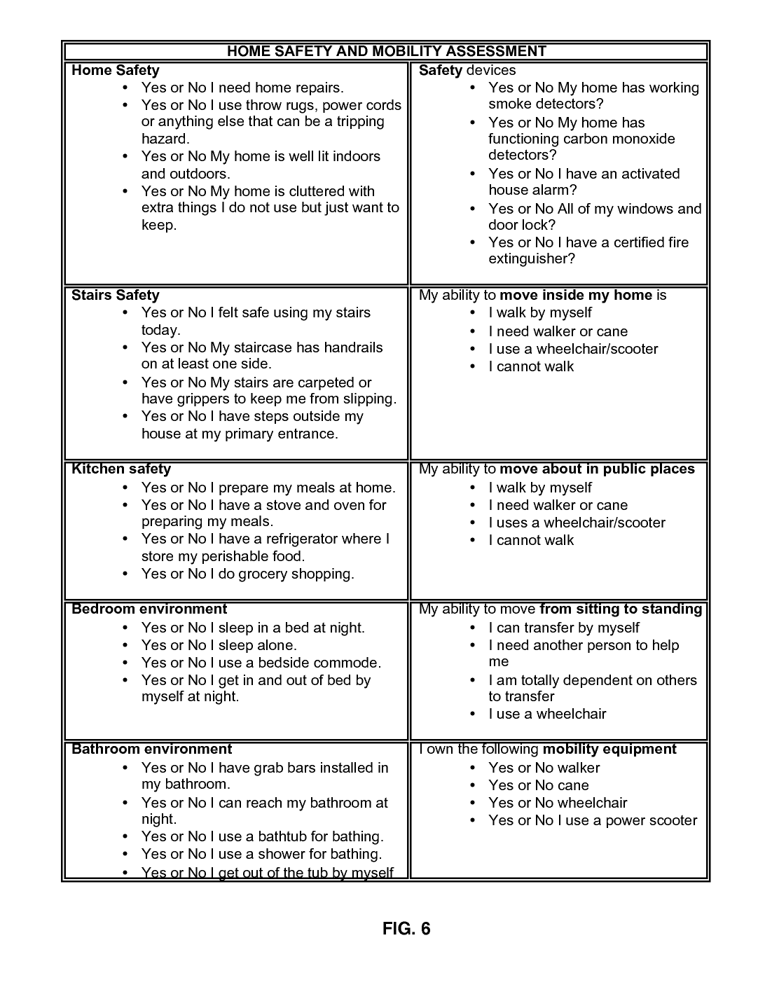

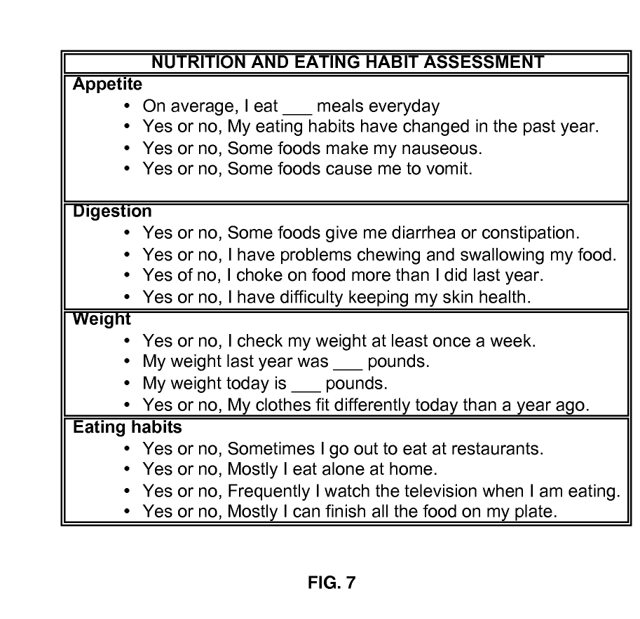

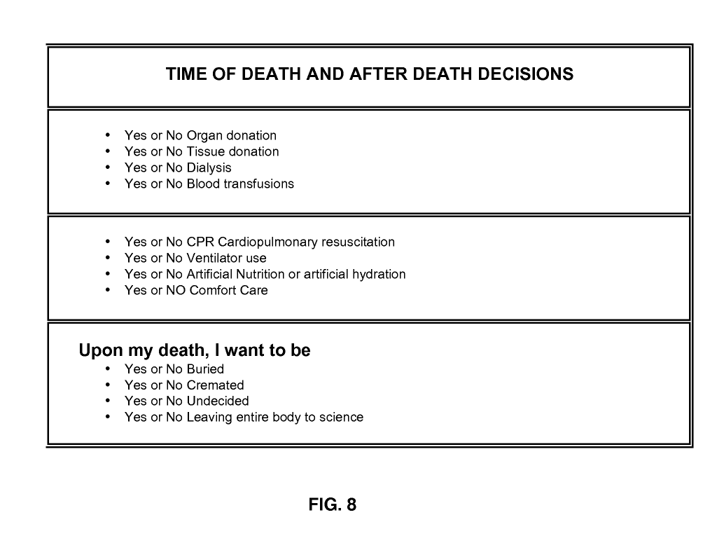

In accordance with the method, a particular participant 30 can sign up for the service by accessing the secure database and providing some basic information. The information can be provided by filling out the Participant Health Care Form depicted in FIG. 4. This form may ask, for example, the name and contact information of the people the participant 30 is closest to. It may likewise ask for the name and contact information of any living relatives. Thereafter, the participant 30 is prompted to provide additional information via a series of on-line self-assessments. Both the form and the self-assessments are preferably completed on-line via interactive web-forms. These forms can be created in a markup language, such as Hyper Text Markup Language (“HTML”). All of the information provided by the participate 30 is secured stored in a database that is compliant with the requirements of the Health Insurance Portability and Accountability Act (“HIPAA”). As noted in FIG. 2, the self-assessments may include, for example, a daily living self-assessment (FIG. 5), a home safety and mobility self-assessment (FIG. 6), a nutrition and eating habit self-assessment (FIG. 7), and an assessment concerning time of death and after death decisions (FIG. 8). The daily living self-assessment (FIG. 5) may inquire about the participant's 30 ability to take needed medication, use the telephone, do laundry, use the bathroom or groom themselves. The home safety and mobility self-assessment (FIG. 6.) may inquire about the participant's 30 ability to use the stairs, kitchen, or bathroom safely. The nutrition and eating habit self-assessment (FIG. 7) may ask questions related to the participant's 30 appetite, digestion, weight, and eating habits. The assessment concerning time of death and after death decisions (FIG. 8) asks questions such as whether the participant 30 wishes to donate organs, what efforts should be made regarding CPR and ventilator use, as well as decisions regarding the participant's burial.

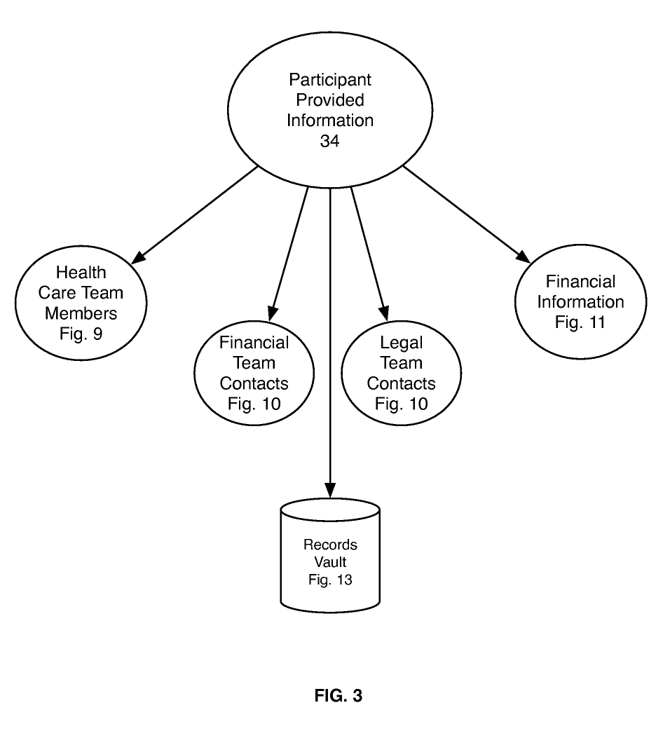

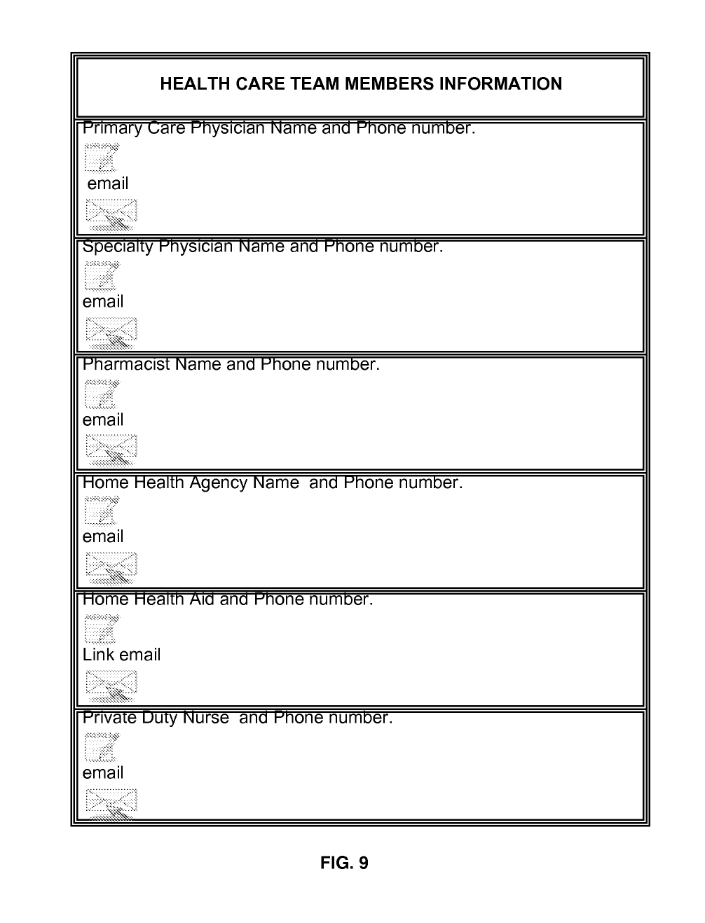

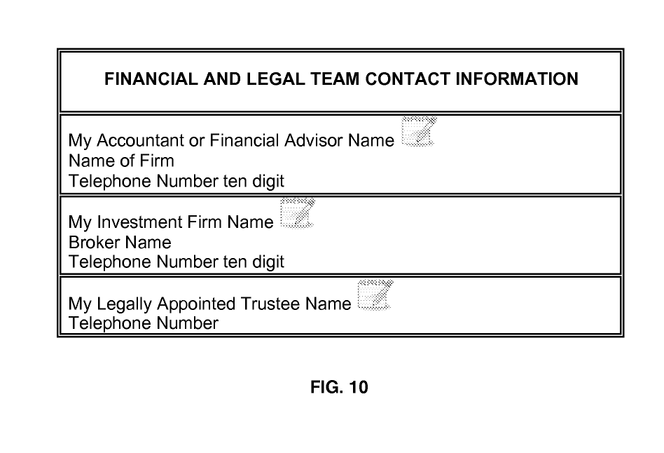

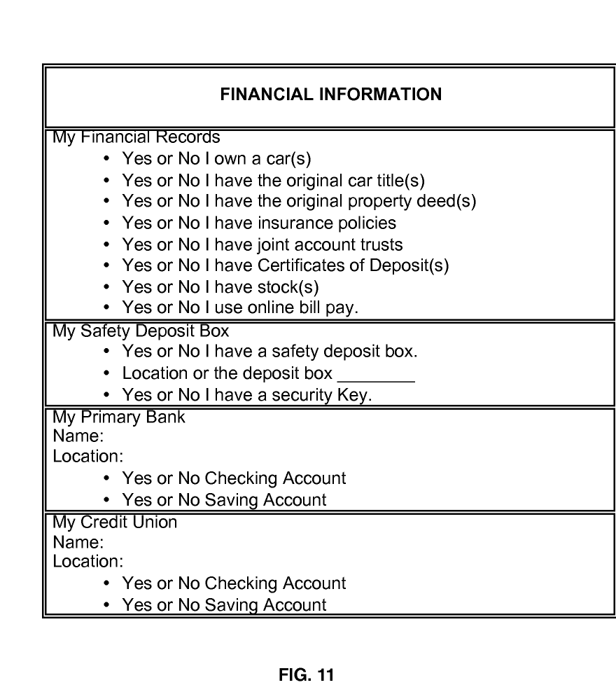

Additional information can be provided by the participant 30 via on-line questionnaires. Again, these may be interactive forms that are completed by the participant 30 while on line. The questionnaires ideally solicit information that is needed for both the day to day and long term care of the participant 30. As noted in FIG. 3, the questionnaires may seek information regarding the participant's health care team members (FIG. 9), financial or legal team contacts (FIG. 10), as well as various financial information (FIG. 11). Again, all of this information would be stored in the secure database.

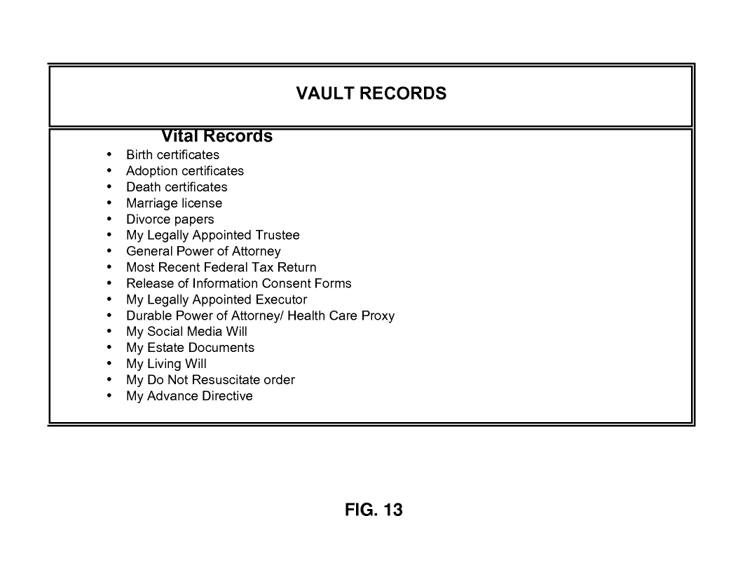

With further reference to FIG. 3, the participant 30 can also upload various vital records to the secure database. These records could thereafter be accessed by either the subscribers 50 or the health care providers 40 in the event the participant 30 dies or otherwise becomes incapacitated. As noted in FIG. 13, these records may include, inter alia, a birth certificate, an estate document, a living will, a do not resuscitate order and an advance directive.

In accordance with the system, information regarding the health care providers 40 caring for the participant 30 can also be uploaded to the database. The uploaded information may include the names of the health care providers, contact information, as well as photographs of the health care providers and/or on-line biographies. This information would be accessible by both the participant 30 and subscribers 50 so that everyone involved in the health care decisions is readily informed.

In accordance with the system, a secure on-line portal is provided to the database. This allows subscribers 50 to access the database and view information related to a participant and the participant's health care providers. The portal also allowing email and video communication between the participant, the health care providers, and the subscribers.

In a preferred embodiment, a website in accordance with the present disclosure may be described with the following site map:

Home sign-in and welcome and care goals

Building your network
Who is important to you?
Health Care team member
About us
   Social worker
   Physician
Contact us
HIPAA forms

Communication Portal
My network (circle)
   Photos of subscribers
      Phone number
      Email address
      Video link
HIPAA secure email
Video chat feed
My caregivers
   Photos
   Caregiver questionnaire

Activities of Daily Living Dashboard
Built in display of questionnaire responses
Depiction of nutrition and eating habits
Activity of Daily Living questionnaire
Home safety and mobility assessment
Nutrition and eating habit assessment
Geriatric Depression Scale

Health Care Portal
Health care team members
   Name address
   Email link
Link—Personally controlled Health Record
   Indivo
Link—Electronic Health Record
   Blue button—Medicare
Link—Social Security Administration
   Use account

Planning tools
Financial and legal team contact information
   Name and address
   Email link
Financial questionnaire
Monthly income and expense worksheets
Commission on Law and Aging Tool Kit

My Vault
Scan, store and lock
   Vital records
   Financial records
   Legal records
   Health care decisions

Resources
Resources linked by headers
Site Search
FAQ
Disclaimer

A website in accordance with the present disclosure may also utilize the following tabs, corresponding to the relevant sections of the site map from above.

### Home

Building a network

Communication Portal

Activities of Daily Living dashboard

Health Care Portal

Planning tools

Vault

Resources

An individual can easily sign up for the online method of the present invention which includes using an email address for an initial username, which will prompt an email with directions for signing in with an assigned username (which will be his or her mobile telephone number without dashes) after which a PIN will be assigned to the new user.

The program of the present invention empowers individuals to take charge of his or her present and future care by pre-defining specific healthcare decisions while still being able to be an active participant in those decisions. Some of the specific choices offered by the method of the present invention may include the following:
Who plays an important role in the participant's life?
Who will the participant turn to when he or she is in need?
Who does the participant trust the most?

The method of the present invention includes the required forms including, HIPAA, Health Insurance Portability and Accountability Act which protects sensitive information and comprises a Notice of privacy practices, an Authorization form and a Patient consent form.

The method of the present invention includes a communication portal portion for completion including the following questions:
1. My network circle (to be populated as subscribers join),
2. Photos of subscribers, their phone numbers, Email addresses and Video link.

The method of the present invention may also include the forms and/or assessments as noted in FIGS. 4-8 for completion by the user. The user may likewise provide the information noted in FIGS. 9-12.

The present invention may also provide for a caregiver questionnaire which is accessible via a link and includes a The American Medical Association Caregiver Self-Assessment Questionnaire.

The Activity of Daily Living questionnaire (note FIG. 5) may also be a component of the present invention.

FIG. 6 illustrates another web page form a participant will use to plan his or her healthcare future relating to home safety and mobility assessment.

FIG. 7 illustrates yet another convenient method a participant will use to plan his or her healthcare future with regard to nutrition and eating habit assessment.

FIG. 9 illustrates another web page a participant will use to plan his or her healthcare future with regard to health care team members.

FIG. 10 illustrates a web page a participant will use to plan his or her healthcare future with regard to financial and legal team contact information.

FIG. 11 illustrates a web page a participant may use to plan his or her healthcare future with regard to financial information.

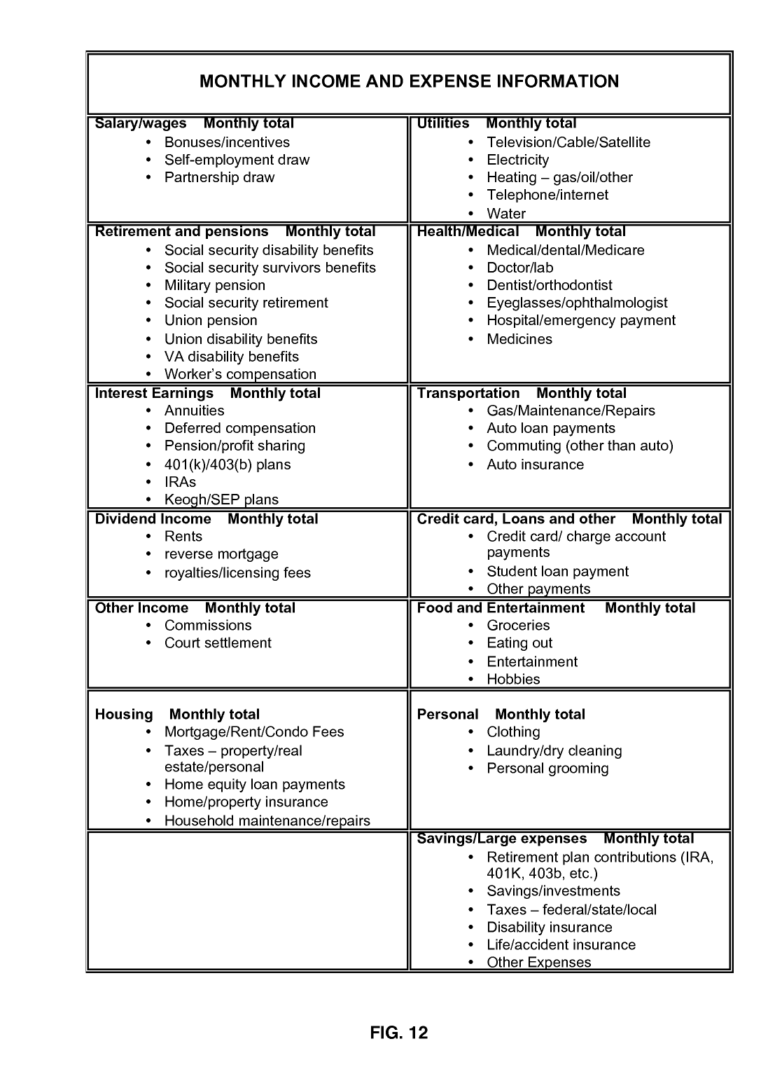

FIG. 12 illustrates a web page a participant will use to plan his or her healthcare future with regard to monthly income and expense worksheets.

FIG. 8 illustrates a web page a participant will use to plan his or her healthcare future with regard to time-of-death and after death decisions.

The present invention may also provide for a Commission on Law and Aging Tool Kit.

FIG. 13 illustrates the types of vital records that a participant can scan and store in a locked vault.

The present invention provides many unique features to appeal to a wide range of users. These features include the following:
User Centered approach with a focus on user and task, empirical measurement and iterative design;
User focused capability directed to capabilities and constraints, simplicity, naturalness, consistency, minimal cognitive load, efficient interactions, forgiveness and feedback, readability;
Usability functionality that is reliable, usable, convenient, pleasurable and meaningful.
Security features is compliant with HIPAA compliant privacy and security regulations.
Scalability feature is adaptable to increased functionality and demand with virtual storage and common platform build.
Portability feature means the ability to utilize the invention via iPhone and iPad apps.

The method of the present invention includes a biopsychosocial connection including proactive outreach to users with a toolbox of planning instruments and vault document storage as shown above to enable consumer and family engagement.

Additionally, the invention is directed to use by social workers, nurses, physicians and discharge planners enabling them to access information and documents for effective admission, discharge and transfer activities.

The method of the present invention further provides for health care payers to adjust the last year of life expenditures in alignment with the user/patient and family wishes and engage government services in developing the most cost effective plan of care.

The biopsychosocial connection of the invention feature consolidates user information in a HIPAA secure, virtual and private health information exchange vaults with quick retrieval.

The invention further provides empowerment tools for user/patients to declare legal, financial and lifestyle instructions for the remainder of their life that is accessible to consumers.

The invention further provides for interoperability electronic health records, personal health records, human service agencies, caregivers, family members and other affiliated professionals.

The present invention has application in numerous fields, uses and facilities including:
Payer
   Medicare
   Medicaid
   Commercial insurance—Early adopter
   Health Maintenance Organizations
Health Care systems
   Accountable Care Organizations
   University Medical Systems
   Non-profit medical systems
   Regional medical systems
Providers
   Patient Centered Medical Home
   Provider Networks
   Medical Associations
   Small and large group practices
   Concierge Medical enterprises—Early adopter
(Target Users
   American Association of Retired People—commercial target Boomers—age 50+
   Sandwich generation—having to care for children and elderly parents
   Parents with disabled and/or terminally ill children)
Health care providers
   Skilled nursing systems/facilities
   Home health care
   Hospice and palliative care organizations
   Pharmacy systems
   Compounding pharmacies
   Laboratory services
   Rehabilitation facilities
   Mental health facilities
   County health departments
Information technology
   EHR vendors
   Mobile health care vendors
Government
   Center for Medicare and Medicaid
   State level departments, health, aging, human services, emergency service
   State Health Information Exchange—Early adopter

The present invention was created to keep seniors out of the long term care facilities (nursing homes and assisted living facilities) in a safe and healthy environment at home. The Long Term Care Diversion program is a recent goal of the Centers for Medicare and Medicaid (CMS) aims to reduce cost of care and increase the happiness and lifespan of senior citizens.

The website content of the present invention will be multimedia. The central feature is the ability for virtual visits between family members. A skyping capability is featured on the home page along with the faces of subscribers.

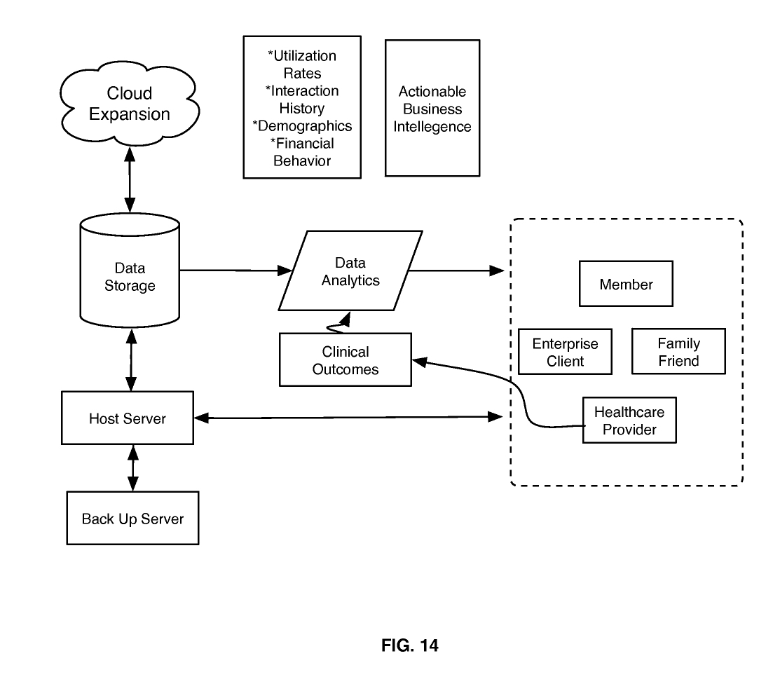

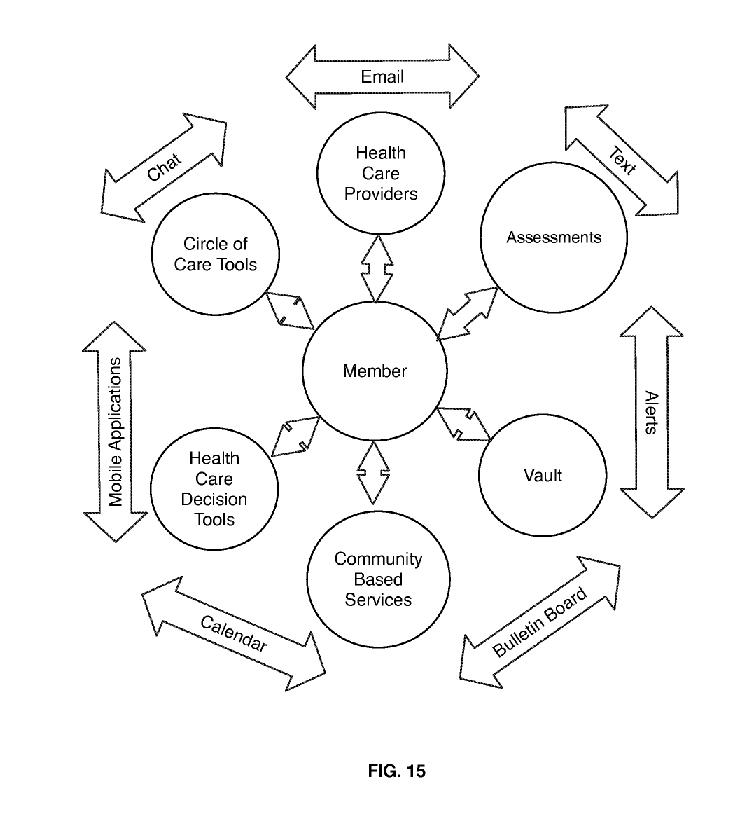

FIG. 14 is a high level schematic showing the features of the present system. The system is advantageous because it detects and prevents fraud and it is transparent and accountable. It also engages both public and private partners. Furthermore, FIG. 15 is another high level schematic of the present system. This schematic shows that the member is the central component of the system. This member can access the vault and assessment features described above. The member also has access his or her health care providers and community based tools. The member has further access to various health care decision tools as well as a circle of care tools. Finally, the interaction between the member and these peripheral individuals or tools can be carried out by any of a variety of communication modes. These modes include, but are not limited to, email, text messaging, on-line chats, cell phone alerts, various mobile applications, as well as calendars and bulletin boards.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for coordinating health care services between a participant, a health care provider, and a subscriber, the method comprising the following steps, the method including a secure database that is accessible by the participant, health care provider and the subscriber over a network, the method comprising the following steps:
gathering information from the participant through a series of self-assessments, the self-assessments that the participant completes on-line and that are stored in the secure database, the self-assessment including a daily living self-assessment, a home safety and mobility self-assessment, a nutrition and eating habit self-assessment, and an assessment concerning time of death and after death decisions;
gathering information from the participant through a series of questionnaires, the questionnaires soliciting information on the participant's health care team, financial and legal team, as well as various financial information;
uploading a plurality of vital records of the participant to the secure database, the vital records including a birth certificate, an estate document, a living will, a do not resuscitate order and an advance directive;
uploading information to the secure database regarding the health care providers caring for the participant, the uploaded information including the names of the health care providers, contact information for the health care providers, as well as photos graphs of the health care providers;
providing a portal for subscribers to gain access to the secure database and thereby view information related to a participant and the participant's health care providers, the portal also allowing email and video communication between the participant, the health care providers, and the subscribers.

2. A method for coordinating health care services between a participant, a health care provider, and a subscriber, the method comprising the following steps, the method including a secure database that is accessible by the participant, health care provider and the subscriber over a network, the method comprising the following steps:
gathering information from the participant through a series of self-assessments, the self-assessments that the participant completes on-line and that are stored in the secure database;
uploading information to the secure database regarding the health care providers caring for the participant, the uploaded information including the names of the health care providers, contact information for the health care providers, as well as photos graphs of the health care providers;
providing a portal for subscribers to gain access to the secure database and thereby view information related to a participant and the participant's health care providers.

3. The method as described in claim 2 wherein additional information relating to the participant is gathered through a series of questionnaires.

4. The method as described in claim 3 wherein the questionnaires solicit information on the participant's health care team, financial and legal team, as well as various financial information.

5. The method as described in claim 2 wherein the self-assessments include a daily living self-assessment, a home safety and mobility self-assessment, a nutrition and eating habit self-assessment, and an assessment concerning time of death and after death decisions

6. The method as described in claim 2 comprising the further step of uploading a plurality of vital records of the participant to the secure database.

7. The method as described in claim 6 wherein the vital records include a birth certificate, an estate document, a living will, a do not resuscitate order and an advance directive.

8. The method as described in claim 2 wherein the portal also allows email and video communication between the participant, the health care providers, and the subscribers.

9. A system for coordinating health care services between a participant, a health care provider, and a subscriber, the system comprising:
a secure database that is accessible by the participant, health care provider and the subscriber over a network:
an on-line portal for gathering information from the participant through a series of self-assessments, the self-assessments that the participant completes being stored in the secure database;
an on-line portal for uploading information regarding the health care providers, the information including contact information of the health care providers, as well as photographs of the health care providers;
an on-line portal for subscribers to gain access to the secure database and thereby view information related to a participant and the participant's health care providers.
